(19) United States
(12) Patent Application Publication
(10) Pub. No.: US 2013/0224614 A1
(43) Pub. Date: Aug. 29, 2013

(54) FIELD-ENHANCED THERMAL DECOMPOSITION OF FUEL STORAGE COMPOSITIONS

(71) Applicant: ARDICA TECHNOLOGIES, INC., (US)

(72) Inventors: Tibor Fabian, San Francisco, CA (US); Daniel Braithwaite, San Francisco, CA (US)

(73) Assignee: ARDICA TECHNOLOGIES, INC., San Francisco, CA (US)

(21) Appl. No.: 13/778,676

(22) Filed: Feb. 27, 2013

Related U.S. Application Data
(60) Provisional application No. 61/603,860, filed on Feb. 27, 2012.

(51) Int. Cl. H01M 8/04

(52) U.S. Cl. CPC H01M 8/04216
USPC 429/429; 429/443; 429/430; 429/434

(57) ABSTRACT

A method of controlled fuel release from a fuel storage composition including applying an electric field to a section of the fuel storage composition, supplying a reagent to the section of the fuel storage composition, measuring a system parameter, and adjusting an electric field parameter based on the system parameter measurement.

### CROSS-REFERENCE TO RELATED APPLICATIONS

This application claims the benefit of U.S. Provisional Application No. 61/603,860 filed 27 Feb. 2012, which is incorporated in its entirety by this reference.

### TECHNICAL FIELD

This invention relates generally to the fuel cell field, and more specifically to a new and useful method and apparatus for fuel release in the fuel cell field.

### BACKGROUND

Fuel cell systems have increasingly been considered as a source of portable, renewable energy. Fuel cell systems typically include a fuel supply containing a fuel and an arrangement of fuel cells that convert the fuel into electric power, wherein the power can be used by a load, such as a portable consumer device or vehicle. In some systems, solid fuel storage compositions that store fuel in a chemically bound form are preferred as the fuel supply, as these storage compositions can store a higher concentration of fuel in a given volume relative to gaseous fuel. Fuel is typically released by reacting the fuel storage composition; typical reaction mechanisms include thermolysis, photolysis, and reaction with a second reagent. Of these, thermolysis and photolysis are preferred to reduce the overall volume of fuel storage.

However, these systems, particularly those utilizing thermolysis, suffer from several issues that become particularly apparent in applications that require intermittent energy production. These issues are mainly due to the high decomposition temperatures of the fuel storage compositions (e.g. on the order of 200° C.-400° C.). First, because the fuel storage composition must be heated up to the decomposition temperature before fuel can be produced, the fuel cell system will experience a power generation lag during the start-up period. Second, heating to such high temperatures requires a large amount of energy input, as does sustaining the temperatures to maintain fuel output. Third, these systems suffer from large heat losses due to the large temperature difference between the fuel storage composition and the external environment. This typically results in a large amount of thermal insulation, which undesirably adds weight and volume to the fuel storage and requires extra energy input to make up for the heat loss. Fourth, these systems suffer from a power cessation lag during shut-off, wherein fuel is still produced even after power demand from the system is ceased. This is because the fuel storage composition cannot be instantaneously cooled under the decomposition temperature.

Thus, there is a need in the fuel cell field to create a new and useful method of fuel release that allows for a more responsive, volumetrically and energetically efficient control of fuel release.

### BRIEF DESCRIPTION OF THE FIGURES

FIG. 1 is a schematic representation of a method of fuel release.

FIG. 2 is a schematic representation of a variation of the dynamic power supply.

FIGS. 3A and 3B are schematic representations of a first and second arrangement of the electrodes relative to the fuel storage composition, respectively.

FIGS. 4A and 4B are schematic representations of a first and second variation of the electrode and reaction element arrangement relative to the fuel storage composition, respectively.

FIG. 5 is a schematic representation of a first variation of the fuel cartridge.

FIG. 6 is a perspective view of a second variation of the fuel cartridge.

FIG. 7 is a perspective view of a third variation of the fuel cartridge.

FIG. 8 is a schematic representation of a fourth variation of the fuel cartridge and a corresponding cartridge receptacle including electrodes.

FIG. 9 is a schematic representation of a fifth variation of the fuel cartridge and a corresponding cartridge receptacle including electrodes.

FIGS. 10A, 10B and 10C are schematic representations of a first, second and third variation of the method of fuel release, respectively.

FIG. 11 is a schematic representation of a variation of the method of fuel release.

### DESCRIPTION OF THE PREFERRED VARIATIONS

The following description of the preferred variations of the invention is not intended to limit the invention to these preferred variations, but rather to enable any person skilled in the art to make and use this invention.

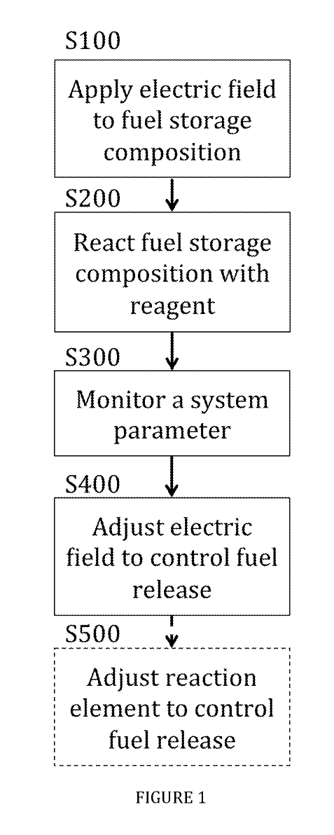

As shown in FIG. 1, a method of releasing fuel from a fuel storage composition includes applying an electric field across a portion of the fuel storage composition S100, reacting the fuel storage composition (FSC) with a reagent to release fuel S200, monitoring a system parameter S300, and adjusting an electric field parameter based on the system parameter S400. This method preferably functions to enable fuel storage composition utilization for intermittent applications by lowering the energy input required to achieve fuel release from the FSC. The application of an electric field to the FSC preferably allows the FSC to decompose, or thermolyse, into fuel at a lower temperature. This lower decomposition temperature can confer several benefits. First, less energy input is required to raise the FSC temperature to the decomposition temperature, allowing for startup energy conservation and a faster startup time. Second, less energy is required to maintain fuel release during operation due to the lower decomposition temperature and lower heat loss to the environment. Third, less insulation of the FSC is required, as the FSC is operated at a lower temperature; this allows for a smaller fuel cartridge form factor and/or more FSC to be included in the same size cartridge. Fourth, because the electric field enables low-temperature fuel release, rapid shut-off can be achieved by simply switching off the electric field; without the electric field, the temperature at which the FSC is held is below the typical FSC decomposition temperature, preventing further fuel release.

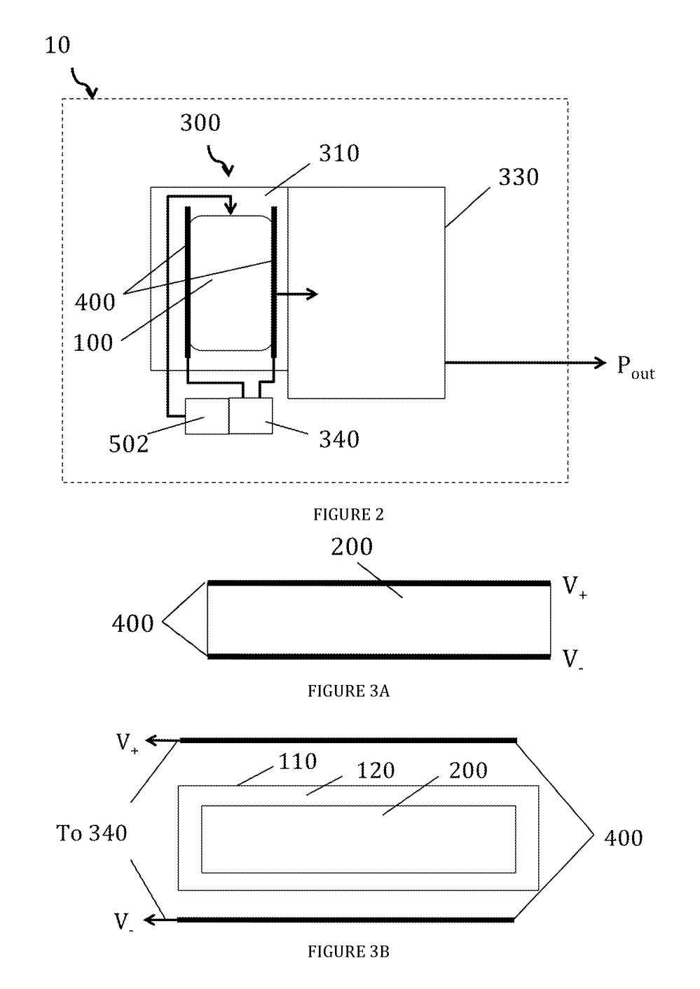

This method is preferably utilized with a dynamic power supply 10 including a fuel storage composition 200 (FSC) disposed between two electrodes 400. More preferably, the method is utilized with a dynamic power supply 10 as shown in FIG. 2, including a fuel cartridge 100 and a fuel cell system 300 that receives the fuel cartridge 100. The dynamic power supply 10 preferably includes electrodes 400, a reaction element 500, and sensors. The dynamic power supply 10 preferably functions to dynamically meet the power demanded by a load by dynamically adjusting the fuel production rate. Alternatively, the method can be utilized with any other suitable power supply system.

The fuel cartridge 100 of the dynamic power supply 10 preferably includes the FSC and a casing no encapsulating the FSC. The fuel cartridge 100 can additionally include insulation 120, a fuel outlet, and/or one or more pressure relief valves (e.g. to prevent cartridge over-pressurization). The fuel cartridge 100 can additionally include any sensors required to regulate cartridge operation, electrodes 400, reaction elements 500, or any other suitable dynamic power supply components.

The fuel storage composition 200 (FSC) functions to store fuel in a chemically bound form that reacts to produce fuel. This fuel is subsequently fed into the fuel cell arrangement 330 and converted into electric power. The FSC preferably stores hydrogen in a chemically bound form (e.g. bound by metallic bonds, ionic bonds, etc.), but can alternatively store methane, propane, or any other suitable fuel in chemical form. The mechanism of FSC reaction into fuel is preferably thermolysis (decomposition into fuel at a decomposition temperature), but can be hydrolysis, electrolysis, photolysis, reaction with another chemical compound, or any other suitable reaction mechanism. Reaction of the FSC preferably produces a gaseous fuel, but can produce a liquid or solid fuel as well. The FSC reaction is preferably endothermic (e.g. to prevent thermal runaway), but can alternatively be exothermic. The FSC is preferably a hydride, more preferably a metal hydride but alternatively any suitable hydride. The FSC can alternatively be a salt or any other suitable compound that chemically binds fuel. The FSC preferably includes Alane (aluminum hydride; preferably α-AlH₃ but alternately any other form of Alane), but can include lithium aluminum hydride (LAH; LiAlH₄), sodium borohydride (SBH; NaBH₄), or any other suitable hydrogen carrier. The FSC is preferably a solid pill or sheet of compressed powder, but can alternatively be a loose powder, a slurry, a fluid, FSC powder suspended in a gel matrix, a gas, or any suitable state of matter. The powder grain size of the FSC is preferably substantially uniform or less than a predetermined size (e.g. passed through a sieve having a constant mesh size), but can alternatively have any suitable size distribution. In the fuel cartridge 100, the FSC is preferably disposed as a thin layer between the electrodes 400 (e.g. on the order of several millimeters or less), such that a high electric field strength (e.g. 5 kV/cm, 2 kV/cm, over 5 kV/cm, etc.) can be achieved over the FSC with a moderate voltage applied at the electrodes 400. However, the FSC can be disposed as a thick layer, a rod, a block, or have any suitable thickness/dimension between the electrodes 400.

The FSC can additionally include additives. These additives can function to increase the effect of the electric field 410 (e.g. locally concentrate the electric field 410), to increase the effect of the reaction element 500, to stabilize the FSC, or have any other suitable effect. In one variation, the additives include electrically conductive pieces that locally concentrate the electric field 410. These pieces are preferably substantially identical (e.g. have a substantially small or normal size distribution), and are preferably linear and pointed at both ends (e.g. needle-like), but can alternatively have any suitable form factor. These pieces can be aligned within the FSC perpendicular to the electric field 410, parallel to the electric field 410, randomly within the FSC, or be arranged in any suitable configuration. In a second variation, the pieces are substantially similar to those of the first variation, but are thermally conductive and/or resistive such that the additive transfers and/or generates heat within the FSC when electric field 410 is applied at the electrodes 400 or when the reagent 502 is applied to the FSC. In a third variation, the additives include chopped optical fibers that transmit light through the FSC body, wherein the fibers can be aligned or randomly oriented within the FSC. In a fourth variation, the additive includes a catalyst (e.g. platinum, palladium, a chemical compound that binds an acid, etc) that is preferably activated upon application of the electric field 410 or the reaction element 500 to the FSC. Additives can additionally include electroluminescent components (e.g. compounds that fluoresce or emit light under the application of an external electric field 410, preferably in the UV wavelength but alternatively in any suitable wavelength), catalysts (e.g. platinum, etc.), or any other suitable additive. The one or more additives can coat the FSC, be mixed substantially isotropically or uniformly throughout the FSC, coat individual sections of the FSC, or be incorporated within the FSC in any suitable manner.

The casing 110 of the fuel cartridge 100 functions to mechanically protect the FSC 200. The casing 110 preferably substantially encapsulates the FSC 200, but can alternatively encapsulate a portion of the FSC. The casing 110 is preferably substantially rigid, and can be made from metal, polymer, ceramic, or any other suitable material. Alternatively, the casing no can be substantially flexible or have any other suitable property. In one variation, the casing no includes an open container (e.g. a prism, cylinder, etc.) and a cap 112 that seals the open end of the container. The cap 112 can be a different material from the container. For example, the cap 112 can be ceramic while the container is metallic. The cap 112 can additionally include electronics required for cartridge operation. When the electrodes 400 are contained within the casing no, the electrode terminals are preferably located on or extend from the cap 112. When the reaction element 500 is contained within the casing no, the reaction element 500 connections (e.g. electrical contacts, fluid contacts, etc.) are preferably located on or extend from the cap 112. However, the electrode terminals and/or reaction element connections can alternatively be located on any other suitable portion of the casing 110. The fuel outlet preferably extends through the cap 112, but can alternatively extend through any other suitable portion of the casing 110.

The insulation 120 of the fuel cartridge 100 functions to maintain the internal temperature of the fuel cartridge 100 and to prevent heat loss/leakage from the cartridge exterior. The insulation 120 preferably maintains the cartridge exterior at a temperature lower than 55° C., more preferably lower than 40° C., during steady state operation. However, the insulation 120 can maintain the cartridge exterior at any suitable temperature. The insulation 120 is preferably thermally insulative, and can additionally be electrically insulative. The insulation 120 is preferably thin, and can be Aerogel, foam, a low-pressure cavity (e.g. vacuum), a ceramic coating, or any other suitable thermal and/or electrical insulator. The insulation 120 can be located between the FSC and the casing 110, the electrodes 400 and the casing 110, the electrodes 400 and the FSC, on the exterior of the casing no, on the interior of the casing no (e.g. within the lumen), define the walls of the casing 110, or be located in any suitable location within or external the casing 110. Alternatively, the casing 110 can include no insulation 120. When the insulation 120 is located between the FSC and electrodes 400 or is located within the cartridge 100, the insulation 120 is preferably a non-dielectric material to minimize arcing, but can alternatively be a dielectric or any other suitable material.

The fuel cartridge 100 can additionally include field concentrators that function to concentrate the electric field 410 within the cartridge 100. The field concentrators are preferably located within the FSC, wherein the FSC is preferably formed into a pellet about the field concentrators. The field concentrators are preferably electrically conductive elements, such as rods, wires, sheets, or any other suitable conductive element. The field concentrator is preferably arranged such that the field concentrator will be substantially perpendicular to the applied electric field 410 (e.g. arranged normal to the thickness of the FSC pellet), but can alternatively be arranged such that the field concentrator will be substantially parallel to the applied electric field 410. However, the field concentrator can be arranged in any suitable manner within the cartridge 100. When multiple field concentrators are used, the field concentrators are preferably arranged in parallel, but can alternatively be arranged in any suitable configuration. The field concentrator is preferably entirely encapsulated within the fuel cartridge 100, but can alternatively extend to the cartridge exterior and be configured to couple to electrical contacts within the cartridge receptacle 310, wherein the contacts can bias the field concentrator at a given potential.

The fuel cell system 300 of the dynamic power supply 10 preferably functions to produce electric power for a load, wherein the fuel cell system 300 preferably includes a cartridge receptacle 310, a cartridge driver 320, and a fuel cell arrangement 330. The fuel cell system 300 preferably additionally includes an electrode pair and a reaction element 500, and can additionally include the sensors. Alternatively, the electrodes 400, reaction elements 500, and/or sensors can be included within the cartridge 100, wherein the fuel cell system 300 preferably includes electrode and reaction element 500 connections, such as electrical or fluid connections. The fuel cell system 300 can additionally include an energy source.

The cartridge receptacle 310 of the fuel cell system 300 preferably receives the cartridge 100 in a lumen defined by the receptacle walls. The electrodes 400, electrode connections, reaction elements 500, and/or portion of the reaction element 500 can define or be located within the receptacle walls. Alternatively, the electrodes 400 and/or reaction elements 500 can be located in any suitable portion of the fuel cell system 300. The cartridge receptacle 310 preferably additionally includes a fuel manifold that fluidly connects the fuel outlet of the cartridge 100 to the fuel cell anodes. The cartridge receptacle 310 preferably substantially encapsulates the cartridge 100, but can alternatively couple to the cartridge base, the cartridge sides, or any other suitable portion of the cartridge 100. The cartridge receptacle 310 can additionally include retention features (e.g. complimentary features to the cartridge 100) that retain the cartridge 100 within the receptacle during cartridge operation. The cartridge receptacle 310 can be made of, or include, thermally and/or electrically insulative material.

The cartridge driver 320 functions to control fuel generation within the fuel cartridge 100. The cartridge driver 320 preferably includes control circuitry (e.g. a processor, connectors, transmitters/receivers, etc.) that is electrically connected to the reaction element 500 and/or the electrodes 400. The cartridge driver 320 can additionally be electrically connected to the sensors, wherein the cartridge driver 320 controls fuel generation based on the sensor measurements. The cartridge driver 320 can additionally function to control fuel cell system operation, wherein the cartridge driver 320 can be electrically connected to the oxygen inlet, the fuel cell heaters, an adjustable load, a secondary energy source (e.g. a battery), or any other suitable component.

The fuel cell arrangement 330 functions to convert the generated fuel into electric power. The fuel cell arrangement 330 is preferably a fuel cell stack, but can alternatively include a single fuel cell, multiple fuel cells arranged in a planar layer, multiple fuel cell stacks, or any other suitable arrangement of fuel cells. The fuel cell arrangement 330 preferably includes one or more fuel cells of the PEM type, high temperature type (e.g. solid oxide fuel cells), or any other suitable fuel cell type, wherein the fuel cells are preferably coupled in series but can alternatively be coupled in parallel. The fuel cells are preferably prismatic, but can alternatively have any suitable form factor.

The fuel cell system 300 can additionally include energy storage, wherein the energy storage can be a DC energy source, an AC source, or a variable power source. For example, the energy storage can be a rechargeable battery (e.g. a lithium ion, lithium polymer, nickel cadmium, etc. battery), wherein the battery can power the electrodes 400, power the reaction element 500, power the load, and/or absorb any excess power generated after load disconnection from the fuel cell system 300.

The electrodes 400 function to generate an electric field 410 over at least a portion of the FSC. In some variations, the electrodes 400 can additionally function as the reaction element 500, such as a heating element. The electric field 410 generated by the electrodes 400 is preferably a DC field, but can alternatively be an AC electric field 410, a pulsed field, or any suitable time variable field pattern. The magnitude and direction of the electric field 410 are preferably adjustable and controlled by a processor (e.g. the processor of the cartridge driver 320). The electrodes 400 are preferably powered by a power source, preferably that of the fuel cell system 300, but alternatively that of the load or by an auxiliary power source. The power source is preferably a variable/programmable power source, but can alternatively be a DC, AC, or any other suitable power source. The electrodes 400 preferably include two electrodes 400 (an electrode pair), wherein one functions as a positive electrode/terminal (cathode) and the other functions as a negative electrode/terminal (anode). The terminal polarities can be substantially permanent (e.g. with a DC power supply), or can be transient (e.g. with an AC power supply). The terminals are preferably coupled to the terminals of a power source (e.g. the positive electrode is coupled to a positive terminal, the negative electrode is coupled to a negative terminal). An electrode is preferably a plate, but can be a flexible sheet, one or more wires, or any suitable electrode. The electrodes 400 can be incorporated into the fuel casing 110 and or insulated parts of electrically conductive casing 110 can serve as electrodes 400. The electrodes 400 can additionally include features that facilitate application of the reaction element 500 to the FSC 200. For example, a plate or sheet electrode can include through-holes (e.g. the electrode is patterned) to allow application of radiation to the FSC surface. Radiation application can be substantially simultaneous with electric field application, or can be controlled independently from electric field application. The electrodes 400 are preferably made of an electrically conductive material, and are preferably metal but can alternatively be any suitable material. Examples of electrode materials include graphite, platinum, nickel, palladium, aluminum, a combination thereof (e.g. Al-plated Pt), or any suitable material. In one variation, the electrode is made of a reaction product of FSC decomposition (e.g. the electrode is aluminum when the FSC is Alane). In a second variation, the electrodes 400 are preferably the same electrodes 400 as those used in fuel production, such that used cartridges 100 can be recycled and serve as a source for new cartridges 100 (e.g. the FSC can be manufactured in the recycled cartridges 100). As shown in FIG. 3A, the electrodes 400 preferably bound a section of the FSC (preferably substantially an entire face of the FSC but alternatively only a portion). The electrodes 400 can be located within the cartridge 100 and directly contact the FSC, wherein the gap distance between the electrodes 400 is preferably substantially small, more preferably substantially the thickness of the FSC. Alternatively, the electrodes 400 can be located distal from the FSC, wherein the electrodes 400 can be located within the cartridge 100 (e.g. separated from the FSC by a gap), in the cartridge receptacle 310 (as shown in FIG. 3B), in the fuel cell system 300, or in any other suitable location. Each fuel cartridge 100 preferably includes at least two electrodes 400 (an anode and a cathode), but can include more (e.g. two cathodes and one anode, multiple cathodes and multiple anodes, multiple anode and cathode pairs, etc.), such that multiple fields can be generated over the FSC. In one variation, the electrodes 400 are substantially flexible metal electrodes 400 (e.g. foil electrodes 400) compressed on either face of a substantially planar section of FSC within the fuel cartridge 100. In a second variation, the electrodes 400 are external to the fuel cartridge 100, and apply an electric field 410 over the FSC through the cartridge casing 110.

The reaction element 500 of the fuel cell system 300 preferably functions to supply a reagent 502 to the FSC and to facilitate FSC reaction into fuel. The reaction element 500 is preferably located within the fuel cell system 300, more preferably within the cartridge receptacle 310, but can alternatively be located within the cartridge 100. The reaction element 500 is preferably a radiation element that supplies radiation having properties suitable to decompose the FSC into fuel. Alternatively, the reaction element 500 can supply a chemical reagent or any other suitable reagent.

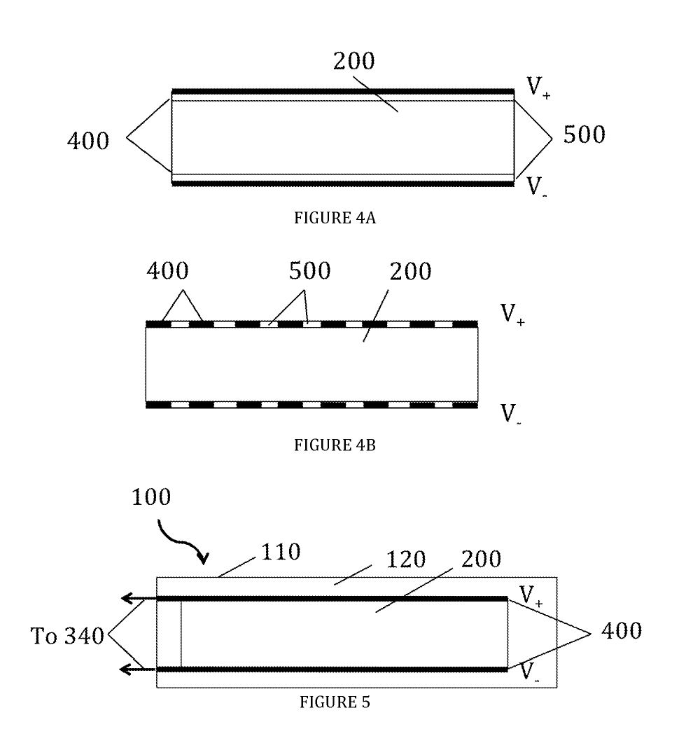

In a first variation of the reaction element 500, the reaction element 500 is a heating element that functions to heat the FSC to the modified decomposition/thermolysis temperature (decomposition temperature after an electric field 410 is applied). The heating element is preferably a resistive heater, but can alternatively be a chemical heater or any suitable heating element. The heating element preferably is or includes the electrodes 400, but can alternatively be a separate element. The separate element is preferably located outside the volume defined by the electrodes 400 (e.g. is located in an area adjacent to the electric field 410), but can alternatively be located between the electrodes 400 (as shown in FIG. 4A), coplanar with the electrodes 400, or in any other suitable position relative to the electrodes 400. In one variation, the heating element and electrodes 400 are alternating strips extending along the broad faces of the FSC (as shown in FIG. 4B). The heating element can be a plate, strip, flexible sheet, one or more wires, a resistor, or any suitable heating element. The heating element is preferably located within the cartridge 100 and directly contacts the FSC, but can alternatively be distal from the FSC (e.g. located within the cartridge receptacle 310), or include a thin insulation layer between the heating element and the FSC.

In a second variation, the radiation element is a light-emitting element (light element). The light element preferably emits light at a wavelength and intensity that photolyses FSC under the influence of an applied electric field 410. The light element preferably emits UV light, but can alternatively emit other wavelengths. The light element is preferably one or more LEDs, but can alternatively be one or more OLEDs or any suitable light-emitting source. The light element can be imbedded along the electrode perimeter, included on the interior of the fuel cartridge 100, included in the cartridge driver 320, or located in any suitable position. In a third variation, the reaction element 500 is an apparatus that facilitates and/or regulates reaction of the FSC with a chemical reactant. The apparatus can be a pump that pumps a fluid reactant (e.g. water, an acid-water mixture, etc.) to a reaction zone of the FSC (e.g. the portion of the FSC to which the electric field 410 is applied). However, the apparatus can be any other suitable mechanism that facilitates reaction of the FSC with a chemical reagent. In a fourth variation, the reaction element 500 is a pressure element that functions to apply pressure to the FSC, which can facilitate fuel release through an increase in temperature or through another mechanism. The pressure element can be the casing no, wherein the casing no is substantially rigid. Upon fuel generation, pressure within the casing 110 (and thus, pressure applied to the FSC) can increase. Alternatively, the pressure element can be a temperature-sensitive element that expands at a temperature substantially near or lower than the modified decomposition temperature, wherein the pressure element expands and applies a compressive force against the FSC. Other pressure elements can be envisioned within the scope of this invention. However, the reaction element 500 can include any suitable mechanism that reacts a reagent 502 with the FSC to release fuel. While a single reaction mechanism is preferably used in addition to the electric field 410 to release fuel from the FSC, multiple reaction mechanisms can alternatively be utilized to release fuel from the FSC.

The fuel cell system 300 can additionally include one or more sensors that monitor the operation of the fuel cell system components. The sensors preferably measure a parameter indicative of fuel cartridge operation, but can alternatively monitor a parameter indicative of fuel cell system operation. The sensors can measure parameters indicative of the fuel production rate (fuel generation rate, fuel release rate, etc.), the fuel temperature, the fuel pressure, the fuel cell temperature, the FSC temperature, the cartridge 100 temperature, the rate of reagent 502 application to the FSC, the amount of reagent 502 application to the FSC, the power output from the fuel cell, the current output from the fuel cell, the electric field magnitude (electric field strength), the electric field direction, arcing within the FSC or cartridge 100, the FSC consumption state (e.g. measuring properties of the light reflected off the partially-consumed FSC), or any other suitable parameter of the fuel cell system 300. The sensors can include one or more timers, power sensors, current sensors, flow sensors, temperature sensors, pressure sensors, voltage sensors, fuel sensors (e.g. catalyst beds), light sensors, or any other suitable sensor. The sensors are preferably electrically connected to the cartridge driver 320, but can alternatively be electrically connected to any other suitable computing component. The sensors are preferably located within the fuel cell system 300, but can alternatively be located within the fuel cartridge 100. The sensors are preferably coupled to the components that the sensors are monitoring (e.g. sensors measuring a system parameter are preferably fluidly coupled to the cartridge interior, receptacle interior, or fuel manifold, etc.), but can alternatively be coupled to a fuel cell system component. For example, the fuel production rate can be determined with a power monitor electrically coupled to the power outlet of the fuel cell system 300, wherein power production is directly correlated with the fuel production rate.

In a first variation of the fuel cell system 300, the electrode pair is located within the fuel cell system 300. The electrodes 400 are preferably located within the cartridge receptacle 310, and are preferably electrically connected to the energy source through the fuel cell system body. However, the electrodes 400 can be located within any other suitable portion of the fuel cell system 300. The electrodes 400 are preferably configured to contact the fuel cartridge exterior when the fuel cartridge 100 is within the receptacle, but can alternatively be arranged substantially adjacent the fuel cartridge 100 (e.g. without physical contact). The electrodes 400 are preferably configured such that the electrodes 400 bound the FSC thickness (e.g. the smallest dimension of the FSC pellet). The electrodes 400 can be patterned (e.g. arranged in strips, include through-holes, include areas of high resistivity, etc.) or can be substantially uniform. The electrodes 400 are preferably statically fixed within the cartridge receptacle 310, but can alternatively rotate about the cartridge 100 longitudinal axis, be transiently fixed, or couple to the cartridge receptacle 310 in any other suitable manner. In this variation, the fuel cartridge 100 preferably includes one or more thin pellets of FSC, wherein the FSC is preferably loaded into the cartridge 100 and compressed within the cartridge 100, but can alternatively be pre-formed (e.g. extruded, sintered, etc.) and loaded into the cartridge 100. In this variation, the reaction elements 500 are preferably located within the cartridge receptacle 310, but can alternatively be located within the fuel cartridge 100, wherein the cartridge receptacle 310 preferably includes reaction element 500 connections (e.g. electrical connections, fluid connections, etc.).

In a first example of the fuel cell system 300, the fuel cell system 300 includes a cartridge receptacle 310 that accepts a cartridge 100 with two broad faces. The received cartridge 100 is preferably substantially thin and planar, but can alternatively be thin and curved, angled, or have any other suitable geometry. The cartridge receptacle 310 is preferably dimensioned substantially similarly to the cartridge 100, but can alternatively have different dimensions. The cartridge receptacle 310 preferably includes a pair of electrodes 400 opposing each other across the lumen thickness. More preferably, the cartridge receptacle 310 includes multiple pairs of electrodes 400, each electrode opposing the respective paired electrode across the lumen thickness. The electrode pairs preferably extend laterally (e.g. stack along the height, or longitudinal axis, of the receptacle), but can alternatively extend longitudinally (e.g. stack along the width, or lateral axis, of the receptacle). The electrode pairs are preferably individually operated, such that different sections of the FSC within the cartridge 100 can be independently subjected to an applied electrical field. However, the electrode pairs can be operated simultaneously, operated based on an adjacent electrode pair operation state, or operated in any suitable manner. Alternatively, the cartridge receptacle 310 can include a single electrode opposing multiple electrodes 400 across the lumen, wherein the multiple electrodes 400 are preferably operated at the same polarity (e.g. the polarity opposing the single electrode polarity) and can be individually operated to selectively apply electric fields to the FSC section adjacent the respective electrode. In another alternative, the electrode pair can include a first electrode located within and extending longitudinally through the receptacle lumen and a second electrode that extends along the cartridge receptacle 310 wall. This can be particularly desirable if the cartridge 100 is a cylinder with a hollow core. The first electrode preferably traces the inner diameter of the cartridge 100, and the second electrode preferably traces the outer diameter of the cartridge 100. More preferably, the first electrode extends through the cartridge 100 along the longitudinal axis (e.g. through the cartridge 100 core) while the second electrode preferably traces the cartridge outer diameter when the cartridge 100 is coupled to the receptacle. The first, second, or both electrodes 400 can be sectioned and individually controlled, such that electric fields 410 can be selectively applied to independent sections of the FSC within the cartridge 100.

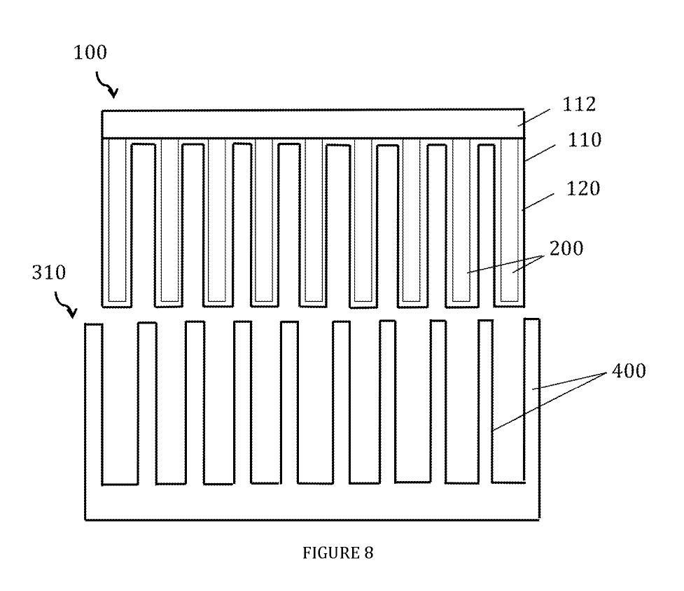

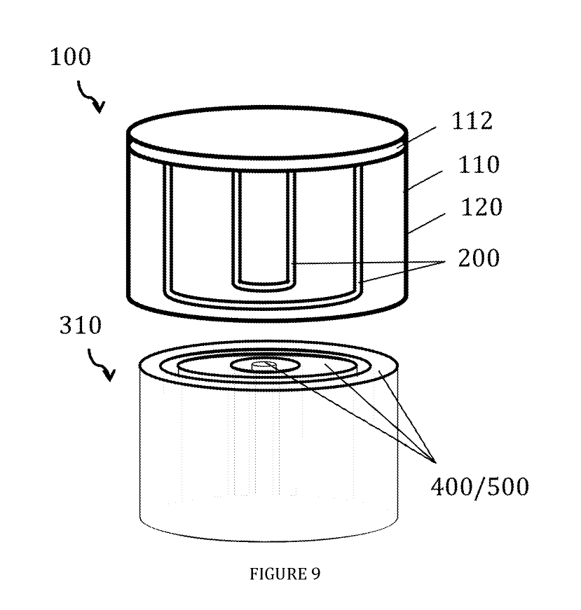

In a second example of the fuel cell system 300, the fuel cell system 300 includes three or more electrodes 400 within the cartridge receptacle 310, arranged with the normal vectors of the electrode broad faces aligned (e.g. when planar electrodes 400 are arranged in parallel). The fuel cell system 300 preferably accepts cartridges 100 carrying one or more FSC pellets. When the cartridge 100 carries multiple FSC pellets, the distance between the multiple pellets is preferably substantially equal to or larger than the thickness of an electrode, such that the electrodes 400 are interdigitated between adjacent pellets when the cartridge 100 is inserted into the cartridge receptacle 310. The spacing between each of the three or more electrodes 400 is preferably substantially equal to the thickness of the FSC within the cartridge 100 (e.g. on the order of several millimeters), but can alternatively be substantially equal to the combined thickness of the FSC, the insulation 120 and the casing 110; the combined thickness of the FSC, the reaction element 500, and the casing 110; the combined thickness of the FSC, the insulation 120, and the reaction element 500; or any other suitable distance. The electrodes 400 preferably have substantially identical dimensions, but can alternatively have substantially different dimensions (e.g. for alignment purposes). In operation, adjacent electrodes 400 are preferably held at different polarities, such that an electric field 410 is applied to the FSC arranged between adjacent electrodes 400. The electrodes 400 can additionally function as structural components, supporting and maintaining the cartridge position within the receptacle. As shown in FIG. 8, the electrodes 400 are preferably substantially planar, particularly when the FSC pellets are substantially prismatic. The electrodes 400 can alternatively be curved, particularly when the FSC pellets are curved. For example, as shown in FIG. 9, the multiple electrodes 400 can be arranged as concentric circles, wherein the FSC is arranged in complementary concentric circles within the cartridge 100.

In a second variation of the fuel cell system 300, the electrodes 400 are located within the fuel cartridge 100. The fuel cell system 300, more preferably the cartridge receptacle 310, preferably includes electrical connections that electrically couple the electrodes 400 to the energy source. In this variation, the reaction element 500 can be included within the fuel cartridge 100, wherein the cartridge receptacle 310 further includes reaction element 500 connections (e.g. electrical or fluid connections) that couple the reaction element 500 to the reagent 502 or the energy source. Alternatively, the reaction element 500 can be located within the fuel cell system 300.

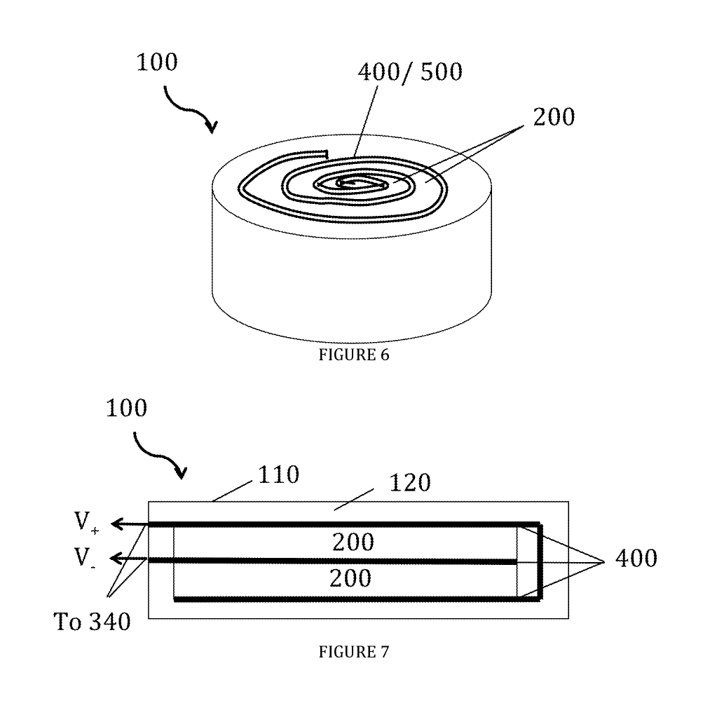

In an example of the fuel cartridge 100, the fuel cartridge 100 includes a substantially rigid case encapsulating insulation 120 and a thin layer of FSC between two electrodes 400, wherein the insulation 120 substantially surrounds the electrode/FSC arrangement. As shown in FIG. 5, the fuel cartridge 100 is preferably substantially planar and prismatic. In this variation, the FSC is preferably a compressed pill. The FSC pill is preferably manufactured by placing FSC powder between two planar electrodes 400 (e.g. plates or foil) and applying a compressive force perpendicular to the planar faces of the electrodes 400. Alternatively, the FSC pill can be manufactured by compressing FSC powder into a pill, then coupling electrodes 400 to the planar faces of the pill by compression, adhesion, coating, deposition, or any other suitable form of application. The electrodes 400 can be patterned with through-holes (for photolysis) and/or include areas with higher resistance (for thermolysis). Alternatively, shown in FIG. 6, the fuel cartridge 100 can be cylindrical. This variation is preferably manufactured by layering FSC powder between two electrodes 400, securing the powder between the electrodes 400 (e.g. by sealing the edges of the electrode/FSC arrangement, coupling the electrode edges together with a dielectric, slightly compressing the electrode/FSC arrangement, etc.), and rolling the electrode/FSC arrangement into a cylindrical structure. The rolled electrode/FSC arrangement is preferably inserted into insulation 120, then inserted into a cartridge 100 case. Alternatively, the rolled electrode structure can be pre-fabricated, and FSC powder subsequently filled into the gaps between the electrodes 400. The latter variation can allow the rolled electrode structures to be supplied to the consumer separately from the FSC powder, wherein the consumer finishes the cartridge 100 manufacture by filling the FSC powder into the cartridge 100.

In another example of the fuel cartridge 100, as shown in FIG. 8, includes a substantially rigid case encapsulating insulation 120 and a volume of FSC interspersed between three electrodes 400. Of the three electrodes 400, the first and third electrodes 400 are preferably of the same polarity, wherein the second electrode is preferably of the opposing polarity (e.g. two cathodes and one anode, two anodes and one cathode). The electrodes 400 are preferably arranged such that the second electrode is located between the first and third electrodes 400, wherein a first and second FSC pill (preferably of the same porosity and thickness, but alternatively of varying porosity and/or thickness) are located between the electrodes 400. This variation is preferably manufactured by laying the first electrode on a flat surface, depositing a layer of FSC powder over the first electrode, laying the second electrode over the first FSC powder layer, depositing a second layer of FSC over the second electrode, laying the third electrode over the second FSC layer, and compressing the electrode/FSC assembly to achieve the desired FSC thickness. In one variation, the first and third electrodes are a continuous sheet, and the second electrode has a dimension that is substantially half of a sheet dimension (e.g. the second electrode is half as long as the first/third electrode sheet). In this variation, FSC powder is layered over half of the electrode sheet, the second electrode is applied over the FSC powder layer, a second FSC powder layer is deposited over the second electrode, and the electrode sheet is folded over the second FSC powder layer to create the desired electrode/FSC arrangement. In a variation of the manufacturing method, the electrode/FSC assembly can be compressed after each FSC layer deposition (e.g. the first FSC layer is partially compressed, such that second FSC layer compression achieves the desired FSC layer thicknesses for both the first and second FSC layers, wherein the first and second FSC powder layer thickness are tailored to achieve the desired porosity and thickness). In another variation of the manufacturing method, the electrode/FSC is first compressed after the second electrode is layered over the first FSC layer, and compressed a second time after the third electrode is applied. Alternatively, the first and second FSC layers can be pre-compressed, wherein the electrode/FSC arrangement is manufactured by coupling the first and second electrodes 400 to a first and second broad face of the first FSC pill, the third electrode is coupled to a first broad face of the second FSC pill, and the second broad face of the second FSC pill is coupled to the uncoupled broad face of the second electrode.

As a person skilled in the art will recognize, other variations of the dynamic power supply 10 can be envisioned in the scope of this invention.

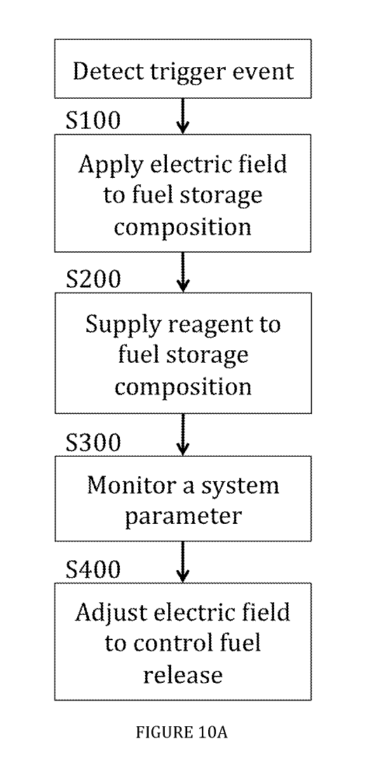

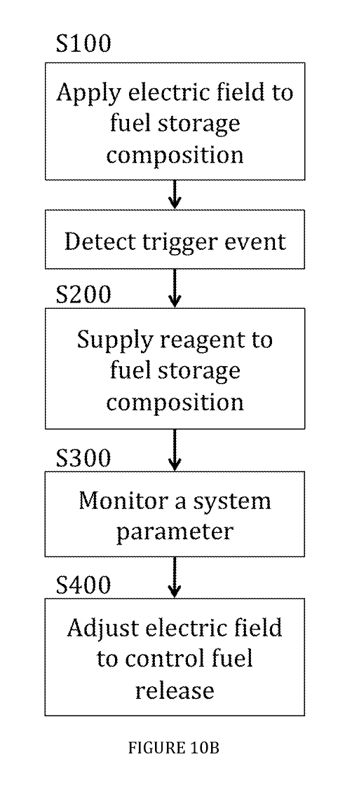

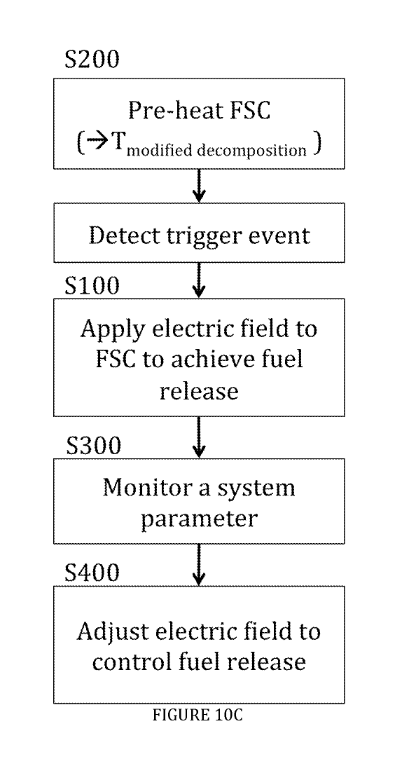

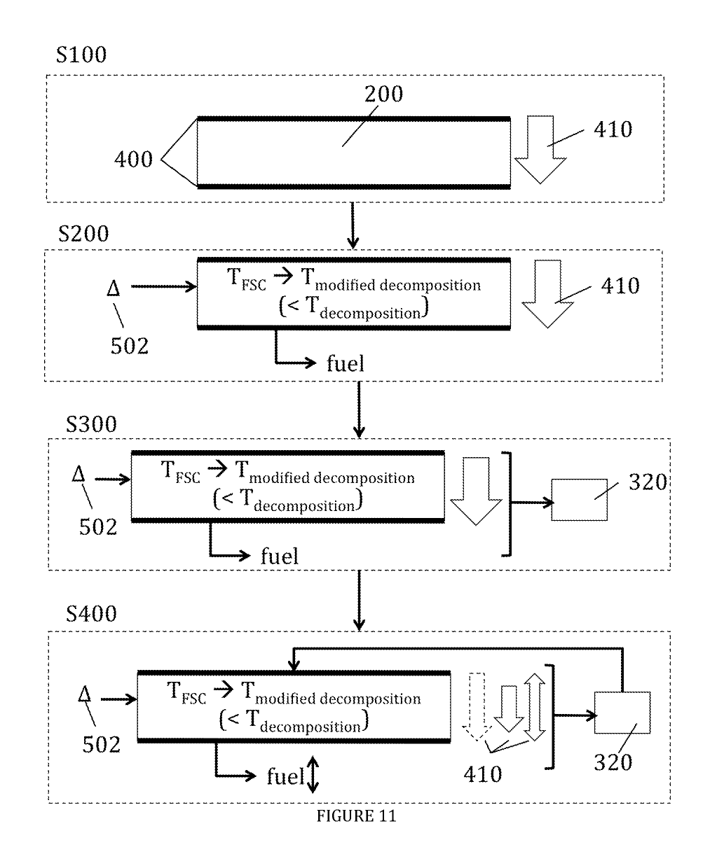

As shown in FIG. 1, applying an electric field across a portion of the fuel storage composition S100 functions to lower the amount of reagent required to achieve fuel release from the FSC. More preferably, the applied electric field lowers the decomposition temperature of the FSC, but can additionally lower the photolysis intensity of the FSC, change the photolysis wavelength of the FSC, or adjust any other suitable parameter of fuel release from the FSC. The magnitude of the applied electric field is preferably lower than that required to electrolyze the FSC (e.g., electrolysis magnitude) or required to cause dielectric breakdown of the FSC (e.g., dielectric breakdown magnitude, dielectric breakdown voltage, dielectric breakdown current, etc.), such that the applied electric field does not decompose the FSC into fuel but places the FSC into an easily reacted state (e.g. with a lowered activation energy). Alternatively, the electric field can be strong enough to electrolyze the FSC into fuel directly without the need for additional reagents. The electric field is preferably applied to one section of FSC at a time (e.g. such that the entire body of FSC is not simultaneously reacted), but can alternatively be applied to multiple FSC sections or the entire FSC body. Because only the FSC section under the electric field will react at the modified decomposition temperature, this method can function to substantially isolate and control FSC reaction to certain sections. The electric field is preferably applied between two electrodes on either side of a FSC section (e.g. across the FSC pill thickness), but can alternatively be applied by a magnetic field (e.g. a time-varying magnetic field). The electric field is preferably applied by coupling the electrodes to a power source (e.g. completing the electrode-power source circuit by switching a switch), but can alternatively be applied by turning the power source on, or by any suitable method. The electric field is preferably applied by biasing a first electrode at a first potential and biasing a second, opposing electrode at a second potential, wherein the first potential is different from the second potential. In one variation, the first electrode is held at a positive or negative non-zero potential, while the second electrode is grounded. However, the electric field can be otherwise applied. The applied electric field is preferably a DC field, but can alternatively be an AC field. The DC field can be supplied by a DC power source (e.g. a battery), or can be supplied by converting AC power into DC power with a rectifier circuit. Likewise, the AC field can be supplied by an AC power source, or can be supplied by converting DC power into AC power with an inverter circuit. The magnitude of the applied electric field is preferably large enough (e.g. the electric field strength over the FSC portion is large enough) to lower the decomposition temperature of the FSC portion to a desired modified decomposition temperature, but can alternatively be larger or smaller. The applied electric field is preferably on the order of kV/cm, but can alternatively be higher or lower. For example, the electric field applied to a substantially pure Alane pellet is preferably approximately 5 kV/cm, but can alternatively be lower (e.g. particularly when the pellet is doped with additives). The electric field strength is preferably selected from a predetermined chart, table or graph based on the current FSC temperature and/or decomposition state, but can alternatively be calculated given inputs of the cartridge operation state (e.g. FSC temperature, etc.), empirically determined (e.g. by raising the electric field magnitude a given increment, heating the FSC to a predetermined temperature/by a predetermined increment, and determining the fuel production rate), controlled by a control loop based on target variable such as fuel flow rate, fuel cell current, fuel temperature, fuel pressure or determined in any suitable manner. As shown in FIG. 10A, S100 is preferably performed when a trigger event is met. The trigger event is preferably indicative of a need for fuel; example trigger events include the coupling of a load to the fuel cell system, turning on the fuel cell arrangement, turning on the cartridge driver, or coupling a cartridge to the cartridge receptacle.

Reacting the fuel storage composition with a reagent to release fuel S200 functions to release fuel from the FSC. The reagent is preferably applied to (e.g. supplied, placed in contact with, etc.) the FSC concurrently with electric field application, but can alternatively be applied before electric field application. S200 is preferably performed upon the occurrence of a trigger event, such as the ones described above (e.g. as shown in FIGS. 10A and 10B), but can alternatively be performed before the occurrence of the trigger event. However, the FSC can be reacted in response to detection of any suitable event. The reagent is preferably supplied to the FSC at a modified reagent supply rate, wherein the modified supply rate is preferably less than a reagent supply rate required to react the FSC in the absence of an applied electric field (unmodified or critical reagent supply rate). In one variation, as shown in FIG. 11, S200 includes holding the FSC at a modified decomposition temperature. S200 can additionally include heating the FSC to the modified decomposition temperature. The modified decomposition temperature is preferably lower, more preferably significantly lower, than the decomposition temperature of the FSC without an applied electric field. The modified decomposition temperature can be calculated given the fuel cell system parameters (e.g. the magnitude of the electric field, FSC consumption state, fuel production rate, etc.), selected from a table given the fuel cell system parameters, or determined empirically, wherein the FSC section temperature is increased (heated) a predetermined increment and subsequently increased or lowered dependent on the difference between the fuel production rate and the desired fuel production rate. The FSC is preferably heated by resistive heaters, but can alternatively be heated by waste heat from the device or the fuel cell system (e.g. from the fuel cell arrangement or a previously used fuel cartridge). In a second variation, S200 includes exposing the FSC section to light to photolyse the FSC. The wavelength, frequency, and intensity of the light is preferably selected, calculated, or determined based on the fuel cell system parameters. In a third variation, S200 includes supplying a chemical reagent to an FSC reaction front, wherein the rate of chemical reagent supply is preferably selected, calculated, or determined based on the fuel cell system parameters. The chemical reagent can be water, an acid solution, or any suitable reagent, and is preferably pumped to the FSC reaction front, but can alternatively be sprayed, wicked, or introduced in any suitable manner. S200 is preferably controlled by a control loop that controls the FSC reaction (e.g. by controlling the power applied to the heaters, controlling light properties, controlling the reagent supply rate, etc.).

Monitoring a system parameter S300 functions to determine the substantially instantaneous state of system operation. The system parameter is preferably indicative of the power output of the system (power parameter), more preferably indicative of the fuel production rate of the system (fuel parameter), wherein the fuel production rate is preferably directly correlated with the power output of the system. By monitoring the system parameter, rapid determination of the discrepancy between the power supply and the power demand can be achieved, which can subsequently allow for dynamic response to changes in fuel demand. Fuel cell system operation is preferably subsequently adjusted based on the system parameter measurement, such that the power supplied from the fuel cell system substantially matches the power demand. The system parameter is preferably monitored during reagent application to the FSC section, but can alternatively be monitored before or after reagent application. The system parameter is preferably monitored by a sensor that sends system parameter measurements to a processor (e.g. the cartridge driver), but can be otherwise monitored (e.g. from information provided by the load, such as power demand). Multiple system parameters can be simultaneously monitored, wherein subsequent adjustment of the fuel cell system parameters can be based on a single system parameter measurement or on a combination of system parameter measurements.

The system parameter is preferably indicative of the substantially instantaneous fuel production rate, but can additionally or alternatively be indicative of the projected fuel production rate. Monitoring a system parameter indicative of the substantially instantaneous fuel production rate can include measuring the substantially instantaneous power production from the fuel cell stack (e.g. wherein the power production rate is directly correlated with the fuel production rate), measuring the fuel flow rate from the cartridge (e.g. wherein the flow rate is preferably directly correlated with the fuel production rate), monitoring reagent parameters (e.g. the reagent supply rate, the amount of reagent supplied, the amount of reagent consumed, the amount of reagent remaining within the cartridge, etc., wherein the fuel production rate is preferably directly correlated with the reagent supply rate), monitoring the FSC operation parameters (e.g. the FSC temperature, pressure, etc., wherein the operation parameters are directly correlated with the fuel production rate), monitoring the applied electric field (e.g. the magnitude, direction, uniformity, etc., wherein the electric field magnitude is directly correlated with the fuel production rate), measuring the current through the FSC (e.g. wherein the current through the FSC preferably directly correlates with the fuel production rate), measuring the cartridge operation duration, or monitoring any other suitable parameter indicative of the substantially instantaneous fuel production rate.

Monitoring a system parameter indicative of the projected fuel production rate preferably includes monitoring a parameter indicative of fuel provision cessation, but can alternatively include monitoring a parameter indicative of the fuel production rate at a second time point after the substantially instantaneous time point. The parameter indicative of fuel provision cessation can be indicative of a risk of sudden fuel consumption (e.g. due to combustion), or can be indicative of the time until fuel provision cessation, as determined from the estimated remaining fuel within the FSC (e.g. indicative of the remaining cartridge runtime). Monitoring a system parameter indicative the sudden fuel consumption can include monitoring the frequency and/or intensity of arcing or sparking within the cartridge, monitoring the concentration of ambient air within the cartridge, or monitoring any other suitable parameter indicative of imminent fuel consumption. Monitoring a parameter indicative of the fuel remaining within the FSC is preferably determined from the historical measurements of the system parameters mentioned above. The amount of fuel remaining within the FSC and/or the remaining cartridge runtime can be extrapolated from historical parameter trends (e.g. from the rate of change of the instantaneous fuel production rate), selected from charts or graphs based on the system parameter measurement, or otherwise determined. Alternatively, the amount of fuel remaining within the FSC can be determined empirically, such as by monitoring the FSC section consumption state as determined from the FSC conductivity, reflectivity, or any other suitable FSC parameter.

Monitoring a system parameter can additionally include determining a substantially instantaneous fuel production rate from the system parameter. The processor preferably processes (e.g. calculates, derives, extrapolates, selects, or otherwise determines) a fuel production rate from the system parameter, but any other suitable component can alternatively determine the fuel production rate.

Monitoring a system parameter can additionally include storing the system parameter measurements. The system parameter measurements are preferably stored within a memory component (e.g. flash memory, etc.) within the fuel cell system, but can alternatively be stored on a memory component within the cartridge. Storage of the parameter measurements is preferably temporary (e.g. stored for the duration of an operation cycle, stored for the duration of the cartridge use within the fuel cell system, etc.), but can alternatively be persistent. In one variation, higher-level computations, such as trends or thresholds, can be retained while the individual measurements are removed.

As shown in FIGS. 1 and 7, adjusting an electric field parameter based on the system parameter S400, functions to control the fuel production rate. S400 preferably occurs after S100 and S200, but can alternatively be performed in any suitable order. S400 is preferably utilized in the short term to achieve the desired fuel production rate while a change in the reaction element operation parameters (e.g. heating rate) is used to adjust fuel production in the long run. The electric field parameter is preferably an operational parameter of the electrodes generating the electric field, but can alternatively be any other suitable parameter. In this step, only the magnitude of the electric field is preferably adjusted, but the direction can be adjusted as well. The electric field is preferably controlled by driving the electrode voltage via a control loop, wherein the control loop maintains the target fuel flow-rate, but can alternatively be controlled by any other suitable means. Adjusting the electric field preferably includes detecting an adjustment event based on the system parameter measurement and adjusting a parameter of the electric field in response to the detection of the adjustment event, but can additionally or alternatively include any suitable methods of adjusting the electric field to achieve the desired fuel output, and subsequently, power output, from the fuel cell system.

Detecting an adjustment event based on the system parameter measurement preferably functions to determine a discrepancy between the instantaneous power supplied by the fuel cell system and the power demand. More preferably, the adjustment event is detected when a discrepancy exists between the actual fuel production rate (e.g. substantially instantaneous or projected fuel production rate) and the desired fuel production rate. The desired fuel production rate is preferably the fuel demand, but can alternatively be any suitable fuel production rate. The fuel demand is preferably determined from the power demand of the load, but can also be determined from the power demand of the energy storage, the substantially instantaneous or projected fuel cell conversion efficiency, or determined from any other suitable parameter indicative of instantaneous or projected fuel consumption. The adjustment event is preferably detected based on a relationship between the system parameter and a system parameter threshold, wherein the adjustment event is preferably detected when the system parameter measurement crosses a threshold or range for the parameter. The threshold or range for the parameter is preferably determined (e.g. selected, calculated, extrapolated, etc.) based on the power demand or fuel demand, but can alternatively be a predetermined threshold or range, be selected based on the state of the FSC consumption, or be determined in any other suitable manner.

In a first variation, the adjustment event is detected when the power output, more preferably power output, from the fuel cell stack falls below or exceeds the power demand, wherein one or more electric field parameters are preferably subsequently adjusted to increase or decrease the fuel production rate, respectively. In a second variation, the adjustment event is detected when the fuel flow rate falls below or exceeds a fuel flow rate determined to satisfy the power demand, wherein one or more electric field parameters are preferably subsequently adjusted to increase or decrease the fuel production rate, respectively. In a third variation, the adjustment event is detected when the current through the FSC falls below or exceeds a current threshold or range determined to satisfy the fuel demand, wherein one or more electric field parameters are preferably subsequently adjusted to increase or decrease the fuel production rate, respectively. In a fourth variation, the adjustment event is detected when the FSC consumption state reaches a threshold state, wherein the electric field magnitude is preferably subsequently adjusted to compensate for the increased conductivity of the FSC. Alternatively, the electric field magnitude can be continuously decreased during FSC consumption to achieve a substantially constant fuel production rate. However, the adjustment event can be detected when any suitable system parameter measurement is indicative of the fuel production rate falling below or exceeding the fuel demand, wherein one or more electric field parameters are preferably subsequently adjusted to increase or decrease the fuel production rate, respectively. For example, an adjustment event is detected when the FSC temperature falls outside the threshold range determined to result in the desired fuel production rate, given the electric field parameters. In another example, an adjustment event is detected when the applied electric field magnitude exceeds that required to produce the desired fuel production rate.

Adjusting a parameter of the electric field in response to the detection of an adjustment event functions to rapidly match the fuel production rate to the fuel demand. The electric field magnitude is preferably increased to increase fuel production (and subsequently, power output), and lowered to decrease fuel production. However, any other suitable electric field property can be adjusted in response to the system parameter measurement exceeding or falling below the system parameter threshold. The electric field properties are preferably adjusted by controlling the power supplied by the power source (e.g. disconnecting the electrodes from the power source, decreasing or increasing the voltage applied to the electrodes, etc.), but can alternatively be adjusted through circuitry. For example, field direction can be changed by routing the power through an inverter circuit. Field strength can be adjusted by routing the power through a variable resistor (e.g. potentiometer or an infinite switch) electrically coupled in series or in parallel between the energy source and the electrode. The resistance is preferably increased to decrease the field strength and decreased to increase the field strength, but can be alternatively adjusted to adjust the field strength. The field strength can also be adjusted by electrically coupling or decoupling the electrode with one or more power sources in series to increase or decrease the field strength, respectively. However, the electric field parameters can be otherwise adjusted.

Adjusting a parameter of the electric field S400 can additionally include determining a target property setting for the electric field based on the system parameter. Determining a target property setting preferably functions to determine the parameters of the electric field that are predicted to result in the desired fuel production rate. The electric field property for which a target value or range is determined preferably includes the electric field magnitude, but can additionally include the electric field direction, orientation, uniformity, shape, or any other suitable property of the electric field. The target property value or range is preferably calculated or selected (e.g. from a chart or graph) based on the desired fuel production rate and the substantially instantaneous system operation parameters (e.g. rate of reagent application, state of FSC consumption, etc.). Alternatively, the target property setting can be determined by determining the amount of change in the electric field property that would result in the desired fuel production rate. The amount of change in the electric field property can be determined based on the difference between the desired fuel production rate and the substantially instantaneous or projected fuel production rate as indicated by the system parameter measurement, wherein the amount of change in the electric field property can be calculated, selected (e.g. from a chart or graph), extrapolated (e.g. from a trend), or otherwise determined based on said difference. Alternatively, the amount of change can be a preset increment, wherein the system preferably iterates through the method until the instantaneous or projected fuel production rate substantially matches the desired fuel production rate.

Adjusting a parameter of the electric field S400 can additionally include selecting an electric field operation mode, wherein the system generating the electric field is preferably operable between an increased fuel production mode and a decreased fuel production mode.

The increased fuel production mode preferably functions to rapidly increase fuel production from the cartridge. In one variation of this mode, the magnitude of the electric field is preferably increased to the target electric field magnitude. However, magnitude can be increased to any other suitable magnitude. Alternatively, any other suitable parameter can be adjusted to increase fuel production. The increased fuel production mode is preferably implemented when instantaneous or projected fuel demand (e.g. from the load or from the fuel cell assembly) is higher than the substantially instantaneous or projected fuel production rate as indicated by the system parameter measurement. The field magnitude is preferably increased by adjusting the first potential at which the first electrode is held (e.g. decreasing the first potential if the first potential is negative, increasing the first potential if the first potential is positive), but can alternatively or additionally include adjusting the second potential at which the second electrode is held.

The decreased fuel production mode preferably functions to rapidly decrease fuel production from the cartridge. In one variation of this mode, the magnitude of the electric field is preferably decreased to the target electric field magnitude. However, magnitude can be decreased to any other suitable magnitude. Alternatively, any other suitable parameter can be adjusted to increase fuel production. The decreased fuel production mode is preferably implemented when substantially instantaneous or projected fuel demand (e.g. by the load or from the fuel cell assembly) is lower than the substantially instantaneous or projected fuel production rate as indicated by the system parameter measurement. This can be used to achieve a substantial decrease in fuel production. Alternatively, the electric field can be switched from a DC field to an AC field of substantially the same magnitude, wherein the frequency of the AC field is preferably calculated, selected, or determined based on the desired fuel production rate. This can be used to achieve a minor decrease in fuel production.

In one variation of the method, the decreased fuel production mode is used to shut off fuel production entirely. This is preferably accomplished by shutting off the applied electric field or by reducing the magnitude of the electric field past a threshold magnitude. This preferably has the effect of substantially instantaneously ceasing fuel production, as the FSC preferably produces little to no fuel at the modified decomposition temperature when no electric field is applied. This variation is preferably used when a shutoff event is detected. The shutoff event is preferably the reduction of a power demand (e.g. from a device or the energy storage) beyond a demand threshold, but can alternatively be the removal of a power demand from the fuel cell system, a decoupling of a load from the fuel cell system, or any other suitable shutoff event. The shutoff event can also include the FSC section consumption state decreasing beyond a consumption threshold or any other suitable event that requires fuel production cessation. This variation can additionally be used as an emergency shutoff mechanism, wherein the applied electric field is shut off upon determination of fuel cell system operation beyond a failure threshold.

As shown in FIG. 1, the method can additionally include adjusting a reaction element parameter S500, which, similar to S400, functions to adjust the fuel production rate. More preferably, the reaction element parameter is a reagent parameter that controls the reagent properties (e.g. reagent supply rate). S500 is preferably simultaneously performed with S400 to achieve finer control over the fuel production rate, but S500 can alternatively be performed independently of S400. S500 can be used to achieve a long-term fuel production rate adjustment, whereas S400 is preferably used to achieve a substantially short-term fuel production rate adjustment, due to the more enduring effects of the reaction element. The reaction element parameter is preferably adjusted based on the system parameter measurement. More preferably, the reaction parameter is adjusted based on a relationship between the system parameter measurement and a system parameter threshold. The reaction element parameter is preferably adjusted such that the fuel production rate satisfies the fuel demand with the application of an electric field having a steady state parameter, but can be otherwise adjusted. The steady state electric field parameter is preferably the electric field parameter setting that minimizes total electrical energy expenditure required to release fuel from the FSC. In one variation, the steady state electric field parameter is the steady state electric field magnitude. The steady state parameter is preferably calculated, but can alternatively be empirically determined, selected from a chart or graph, or otherwise determined from the substantially instantaneous or projected fuel demand. This step can additionally determine a steady state reaction element parameter. The steady state reaction element parameter and steady state magnitude preferably cooperatively minimize the total electrical energy input and/or input rate into the FSC, but can be otherwise determined (e.g. selected from a chart, graph, etc.). The reaction element parameter can be gradually adjusted or suddenly adjusted to the steady state reaction element parameter. Alternatively, the reaction element parameter can be adjusted to any other suitable setting.

In a first variation, adjusting the reaction element parameter includes adjusting the heat supplied to the FSC, such that the FSC temperature is adjusted. This is preferably accomplished by selective power provision to the heating elements, but can additionally or alternatively be accomplished by selective control of cooling elements, such as fans, heat pumps, endothermic reactions, or any other suitable cooling element. For example, when the rate of current fuel production exceeds that demanded (i.e. less fuel is demanded), less power can be supplied to the heating elements, no power can be supplied to the heating elements, and/or fans or cooling mechanisms can be initiated to lower the FSC temperature. When the rate of fuel production is lower than that demanded, more power can be supplied to the heating elements and/or cooling elements can be turned off. When the rate of current fuel production is lower than that demanded, more power can be supplied to the heating elements such that the heating elements heat the FSC section at an increased rate.

In a second variation, adjusting the reaction element parameter includes adjusting the properties of the radiation applied to the FSC. This is preferably accomplished by selective power provision to the radiating elements (e.g. lights), wherein increased power provision preferably results in increased radiation, thereby increasing the fuel production, and decreased power provision preferably results in decreased radiation, thereby decreasing the fuel production. However, the radiation properties can also be adjusted by changing the radiation wavelength (e.g. by application of a filter, selective power provision to various radiators each configured to emit a different radiation wavelength, etc.) or by changing any other suitable radiation parameter.

In a third variation, adjusting the reaction element parameter includes adjusting the amount of reagent provided to the FSC reaction zone and/or the area of the FSC reaction zone (e.g. more reagent is provided to increase fuel production, less to decrease fuel production).

Adjusting the reaction element parameter can additionally include estimating the duration of the discrepancy between the fuel demand and the fuel production rate, which functions to determine whether the reaction element parameter should be adjusted. The reaction element parameter is preferably adjusted when the estimated discrepancy duration exceeds a duration threshold. The reaction element parameter is preferably held constant when the estimated discrepancy duration falls below the duration threshold. The duration threshold is preferably substantially equal to the time required for the reaction element parameter adjustments to result in the desired fuel production rate, but can alternatively be otherwise determined.

Adjusting the reaction element parameter can additionally include adjusting an electric field parameter in response to the reaction element parameter adjustment, which preferably functions to compensate for the changes in fuel production caused by the reaction element adjustment. Adjusting the electric field parameters preferably includes reversing the electric field adjustments made in S400. However, adjusting the electric field can include repeating S300 and S400 to empirically adjust the electric field. Alternatively, adjusting the electric field can include calculating a second steady state magnitude for the electric field based on the substantially instantaneous or projected fuel demand and adjusting the electric field parameters to achieve said second steady state magnitude. The electric field parameter is preferably adjusted concurrently with reaction element parameter adjustment, but can alternatively be adjusted before, after, or iteratively with reaction element parameter adjustment. The electric field is preferably adjusted incrementally, more preferably iteratively with reaction element parameter adjustment, but can alternatively be suddenly adjusted. The electric field parameter can be adjusted based on changes in the reaction element parameter. For example, the electric field magnitude can be decreased in response to an increase in the heating rate or radiation intensity, and increased in response to an increase in the heating rate or radiation intensity. Alternatively, the electric field parameter can be adjusted based on the system parameter measurements, wherein the electric field parameter is preferably adjusted to substantially match the system parameter with the system parameter threshold. For example, the electric field magnitude can be decreased in response to an increase of the fuel production rate over a rate threshold and increased in response to a decrease of the fuel production rate under the rate threshold. In another example, the electric field magnitude can be decreased in response to an increase in the FSC section temperature over a temperature threshold (e.g. selected to maintain a desired fuel production rate, and thus, power production rate), and increased in response to a decrease in FSC section temperature under the temperature threshold. However, the electric field parameters can be adjusted based on any other suitable system parameter.

The method can additionally include iterating through S100 to S400 for a second FSC section after the first FSC section is substantially consumed. The state of FSC section consumption is preferably calculated from the system parameter measurements (e.g. by tracking the amount of power or fuel produced from the section), but can also include directly measuring the consumption state, such as by measuring the conductivity through the FSC section (e.g. wherein the conductivity preferably directly correlates with the FSC section consumption), measuring the reflectivity of the FSC section, or measuring any other suitable FSC section parameter.

In a first variation of the method, the fuel cell system detects a trigger event, generates an electric field across a section of the FSC, heats the FSC to the modified decomposition temperature (as determined from the electric field properties), monitors a system parameter indicative of the fuel production rate, and adjusts the electric field to adjust the fuel production rate to meet the fuel demand (e.g. from the load). The electric field can be applied before trigger event detection (as shown in FIG. 10A) or applied trigger event detection (as shown in FIG. 10B).

In a second variation of the method, as shown in FIG. 10C, the fuel cell system is pre-heated with waste heat (e.g. from the device, the fuel cell arrangement, or a previously-used cartridge), generates an electric field of predetermined magnitude upon the receipt of a trigger event, applies a variable amount of heat to adjust the fuel production rate (e.g. more heat for a higher rate, less heat for a lower rate), and adjusts a parameter of the electric field for a fast-response fuel production adjustment. The predetermined electric field magnitude can be the magnitude required to release fuel at the preheated FSC temperature, wherein the properties of the electric field (direction and magnitude) are preferably dynamically changed with the heating rate to maintain and/or achieve the desired fuel production rate. Alternatively, the predetermined electric field magnitude can be less than the magnitude required to release fuel at the preheated FSC temperature, wherein additional heat must be supplied to the FSC section to achieve fuel release.

As a person skilled in the art will recognize from the previous detailed description and from the figures and claims, modifications and changes can be made to the preferred variations of the invention without departing from the scope of this invention defined in the following claims.

We claim:

1. A method of controlled fuel release from a fuel storage composition, comprising:
concurrently applying an electric field to a section of the fuel storage composition and supplying a reagent to the section of the fuel storage composition;
measuring a system parameter; and
adjusting an electric field parameter based on the system parameter measurement.

2. The method of claim 1, wherein applying an electric field to the section comprises biasing a first electrode adjacent the section at a first potential and biasing a second electrode opposing the first electrode across the section at a second potential different from the first potential.

3. The method of claim 1, wherein a magnitude of the electric field is less than a dielectric breakdown magnitude of the fuel storage composition.

4. The method of claim 1, wherein adjusting an electric field parameter based on the system parameter measurement comprises adjusting the electric field parameter based on a relationship between the system parameter measurement and a system parameter threshold.

5. The method of claim 4, wherein the system parameter threshold is determined based on a power demand from a load.

6. The method of claim 5, wherein the system parameter measurement comprises a power output from a fuel cell system, the fuel cell system fluidly connected to the section of fuel storage composition and electrically connected to the load, wherein the system parameter threshold comprises the power demand.

7. The method of claim 6, wherein the electric field parameter comprises an electric field magnitude, wherein adjusting the electric field magnitude comprises:
in response to the power output falling below the power demand, increasing the electric field magnitude; and
in response to the power output exceeding the power demand, decreasing the electric field magnitude.

8. The method of claim 1, wherein the reagent is supplied at a modified reagent supply rate, wherein the modified reagent supply rate is less than an unmodified reagent supply rate required to react the section to release fuel without an applied electric field.

9. The method of claim 8, wherein supplying a reagent to the section comprises supplying heat to the section, wherein a rate of heat supply is less than an unmodified rate of heat supply required to thermolyse the section without an applied electric field.

10. The method of claim 9, wherein supplying heat to the section comprises heating the section with resistive heaters thermally connected to the section.

11. The method of claim 1, further comprising adjusting a reagent parameter based on a relationship between the system parameter measurement and a system parameter threshold.

12. The method of claim 11, wherein the reagent parameter comprises a heating rate, wherein adjusting a reagent parameter comprises:
in response to the system parameter measurement falling below the system parameter threshold, increasing the heating rate; and
in response to the system parameter measurement exceeding the system parameter threshold, decreasing the heating rate.

13. The method of claim 12, wherein decreasing the heating rate comprises selectively removing heat from the section by operating a cooling mechanism thermally connected to the section.

14. The method of claim 12, wherein the system parameter measurement comprises a power output from a fuel cell stack that is fluidly connected to the section of fuel storage composition and the system parameter threshold comprises a power demand from a load electrically connected to the fuel cell stack.

15. The method of claim 11, further comprising adjusting the electric field parameter during the reagent parameter adjustment.

16. The method of claim 15, wherein the electric field parameter is adjusted concurrently with the reagent parameter.

17. The method of claim 15, wherein adjusting the electric field parameter during the reagent parameter adjustment comprises adjusting the electric field parameter to substantially match the system parameter measurement with the system parameter threshold.

18. The method of claim 15, wherein the electric field parameter comprises an electric field magnitude and the reagent parameter comprises a heating rate for the section, wherein adjusting the electric field parameter during the reagent parameter adjustment comprises:
in response to an increase in the heating rate, decreasing the electric field magnitude; and
in response to a decrease in the heating rate, increasing the electric field magnitude.

19. The method of claim 18, further comprising:
determining a steady state electric field magnitude and a steady state heating rate based on a power demand from a load electrically connected to a fuel cell system, the fuel cell system fluidly connected to the section of fuel storage composition, the steady state electric field magnitude and steady state heating rate cooperatively minimizing a total electrical energy input into the fuel storage composition; and
adjusting the electric field magnitude and the heating rate to substantially match the steady state electric field magnitude and the steady state heating rate, respectively.

20. The method of claim 19, wherein adjusting the electric field magnitude and the heating rate to substantially match the steady state electric field magnitude and the steady state heating rate, respectively, comprises incrementally adjusting the electric field magnitude to substantially match the steady state electric field magnitude, and incrementally adjusting the heating rate to substantially match the steady state heating rate.

21. The method of claim 1, further comprising:
detecting a shutoff event; and
ceasing electric field application to the section of the fuel storage composition.

22. The method of claim 21, wherein detecting the shutoff event comprises detecting a reduction of a power demand below a power demand threshold.

23. The method of claim 1, wherein the fuel storage composition comprises a hydride.

24. The method of claim 23, wherein the fuel storage composition comprises aluminum hydride.

25. A method of controlled fuel release from a fuel storage composition, comprising:
concurrently (a) applying an electric field having a magnitude less than a dielectric breakdown magnitude to a section of the fuel storage composition, and (b) supplying a reagent to the section at a modified reagent supply rate less than an unmodified reagent supply rate, wherein the unmodified reagent supply rate is required to react the fuel storage composition section into fuel in the absence of an applied electric field;
monitoring a system parameter; and
adjusting an electric field parameter in response to the system parameter.

26. The method of claim 25, wherein the system parameter is indicative of power demand, wherein adjusting an electric field parameter in response to the system parameter comprises ceasing electric field application to the section when the power demand decreases beyond a demand threshold.

27. The method of claim 25, wherein the system parameter is indicative of fuel production, the method further comprising determining a power demand, wherein adjusting an electric field parameter in response to the system parameter comprises adjusting the electric field between:
an increased fuel production mode comprising increasing an electric field magnitude; and
a decreased fuel production mode comprising decreasing the electric field magnitude
based on a relationship between the system parameter and a parameter threshold determined from the power demand.

28. The method of claim 27, wherein the system parameter comprises a power output from a fuel cell system fluidly connected to the section of fuel storage composition, the method comprising:
adjusting the electric field to the increased fuel production mode when the power output falls below the power demand; and
adjusting the electric field to the decreased fuel production mode when the power output exceeds the power demand.

29. The method of claim 25, further comprising adjusting a reagent parameter based on the system parameter.

30. The method of claim 29, wherein supplying a reagent to the section comprises heating the section, wherein adjusting a reagent parameter comprises adjusting a heating rate of the section based on a relationship between the system parameter and a parameter threshold determined from the power demand, comprising:
increasing the heating rate when the system parameter falls below the parameter threshold; and
decreasing the heating rate when the system parameter exceeds the parameter threshold.

31. The method of claim 30, wherein the system parameter comprises the power output and the parameter threshold comprises the power demand.

32. The method of claim 30, wherein supplying heat to the section comprises heating the section with waste heat from a fuel cell stack fluidly connected to the section.
